(19) United States
(12) Patent Application Publication
(10) Pub. No.: US 2016/0052824 A1
(43) Pub. Date: Feb. 25, 2016

(54) Treated Polyoxymethylene Fibers For Use In Structural Matrices

(71) Applicant: Ticona GmbH, Sulzbach (DE)

(72) Inventors: Hattersheim Herschke, Hattersheim (DE); Arvind Karandikar, Morristown, TN (US); Kaushik Chakrabarty, Florence, KY (US); David Mcllory, Cincinnati, OH (US)

(21) Appl. No.: 14/832,289

(22) Filed: Aug. 21, 2015

Related U.S. Application Data
(60) Provisional application No. 62/041,400, filed on Aug. 25, 2014.

(51) Int. Cl. C04B 16/06; C04B 24/00

(52) U.S. Cl. CPC C04B 16/0675; C04B 24/00

(57) ABSTRACT

Construction materials are described that contain polyoxymethylene fibers. The polyoxymethylene fibers are treated with a sizing composition that improves dispersibility. In addition to improving dispersibility, the sizing composition improves various physical properties of the resulting hardened structural material. The sizing composition, for instance, can increase impact resistance, flexural strength, compressive strength, and/or residual strength in comparison to an identical construction material containing polyoxymethylene fibers that are untreated.

### RELATED APPLICATIONS

The present application is based on and claims priority to U.S. Provisional Patent application Ser. No. 62/041,400, filed on Aug. 25, 2014, and which is herein incorporated by reference.

### BACKGROUND

Concrete is the most commonly used man-made construction material for structural applications in the world. Concrete includes a hydraulic binder component and a component made of a mixture of coarse and fine aggregates. The binder component is cement, which is generally formed of a calcined limestone-based composite, and the aggregate component is generally formed of quartz sand or calcium carbonate. Other construction products for non-structural applications include building products such as industrial mortars. The binder used in industrial mortars can vary and can include a hydraulic binder such as cement or gypsum, a liquid dispersion and fine aggregates.

Improvements in the properties of construction materials have been obtained in the past by combining the material with modifying additives (admixtures). Common modifications to improve these materials include the addition of reinforcing fibrous materials to the binder such as metal, polymeric, glass, and natural fibers, and formation in conjunction with rebar. Synthetic fibers have been used for several decades as a reinforcing agent for concrete, particularly for slab on grade applications. Fiber reinforced concrete can exhibit decreased shrinkage, decreased permeability and even increased abrasion and shatter resistance, depending upon the specific materials used in the composite.

The nature of the fiber reinforcement can vary. Microfibers, ranging from about 1 to about 10 denier are typically used to help prevent plastic shrinkage cracking as the concrete sets. The presence of the microfibers at loadings of about 1 to 3 pounds per cubic yard (lb/yd³) of concrete prevents micro-cracking of the concrete in the first 24 to 48 hours after pouring, as the bulk of the water in the mixture evaporates. Fibrillated or embossed macrofibers in the range of about 1000 denier are often added at loadings of 3 to 8 lb/yd³ as a secondary reinforcement. These fibers are added to improve overall toughness, as quantified by measurements of residual strength after first break on concrete samples containing the fibers (e.g., as measured according to ASTM C-1399). In both cases, the fibers ideally can be easily mixed with the wet concrete mixture and resist separating during the finishing and setting steps. Level of property enhancements to the concrete depends on both the strength of the fiber and adhesion between the fiber and the concrete matrix.

Polypropylene has been the material of choice by the concrete industry for both micro- and macrofibers. Polypropylene fibers can be easily formed via melt spinning (both micro- and macrofibers) or cutting from thin films (e.g., tape fibers or fibrillated fibers). Polypropylene fibers can exhibit tenacity on the order of 5 grams-force per denier (g/den). In addition, polypropylene is alkali resistant, which is critically important for any concrete additive (pH of concrete is typically 11 or higher). However, polypropylene does have disadvantages. Its low density and hydrophobicity combine to make it tend to bloom to the surface during finishing. This can cause surface appearance problems. Further, polypropylene fibers will not chemically bond to concrete, and rely only on mechanical interactions for adhesion to the matrix.

Other materials have been tried in an attempt to mitigate the disadvantages of polypropylene fiber additives. Polyamide fibers have been examined as polyamide is a denser material and thus expected to resist surface bloom. However, the moisture absorption of polyamides, resulting in lower strength and modulus, rendered these fibers less effective overall in concrete applications. Polyvinyl alcohol (PVA) fibers have also been developed for use in concrete. The obvious advantage is the potential for chemical bonding between the concrete matrix and pendant —OH groups on the polymer backbone. However, this sought-after bonding actually led to additional problems. In fact, pretreatment of PVA fibers with formaldehyde (HCHO_{(aq)}) to bind a fraction of the —OH groups as the cyclic formal was found to be necessary to reduce the fiber-concrete interaction and reduce stress in the cured concrete product. In addition, PVA fibers are quite expensive and successful utilization requires an on-site, multistep mixing process with the concrete. Despite these difficulties, PVA fibers have found limited use in specialty concrete applications, such as precast concrete for earthquake-proof structures. Its use beyond these specialty applications has been quite limited.

In view of the above drawbacks of using polypropylene fibers, polyamide fibers and polyvinyl alcohol fibers, recently those skilled in the art have attempted to incorporate fibers made from a polyoxymethylene polymer into construction materials. For instance, U.S. Patent Publication No. 2012-0157576, which is incorporated herein by reference, discloses a concrete containing polyoxymethylene fibers. The use of polyoxymethylene fibers in construction materials has proven to be a significant advancement in the art. The polyoxymethylene fibers can mix well with wet materials and resist surface blooming during set. The polyoxymethylene fibers are also chemical resistant and can significantly improve the physical properties of the hardened material.

The present disclosure is directed to further improvements in incorporating polyoxymethylene fibers into construction materials.

### SUMMARY

In general, the present disclosure is directed to coated polyoxymethylene fibers and to a construction material containing the fibers. As used herein, a “construction material” refers to any type of powder-like or granular material that can be formed into a liquid slurry or paste and hardened. Examples of construction materials include cements, mortars, grouts, underlayments, overlayments, and the like. The term also covers any gypsum-containing material that can be hardened, including drywall panels. All plasters and similar paste-like materials are also considered construction materials as used herein. The construction material can be structural or can be for decorative applications. The construction material may only comprise a binder or may comprise a binder in combination with an aggregate.

In accordance with the present disclosure, the fibers are produced with a polyoxymethylene composition. The fibers are made to have a specific length and size for incorporation into a construction material, such as a reinforcing material. In addition, a sizing composition is applied to the fibers that improves dispersibility and storage stability. Further, it was unexpectedly discovered that the use of particular sizing compositions can dramatically improve the physical properties of the resulting material once hardened and cured.

According to one embodiment, the present disclosure is directed to a construction material containing a binder, optionally an aggregate and a plurality of discrete fibers. The discrete fibers are produced from a polyoxymethylene polymer, such as a polyoxymethylene copolymer. In one embodiment, the polyoxymethylene polymer contains terminal functional groups, such as terminal hydroxyl groups. In one embodiment, for instance, the polyoxymethylene polymer contains hydroxyl terminal groups in an amount greater than about 10 mmol/kg, such as greater than about 15 mmol/kg, such as greater than about 20 mmol/kg, such as greater than about 25 mmol/kg, such as greater than about 30 mmol/kg. The polymer can also have a melt index of from about 2 g/10 min to about 50 g/10 min when measured at 190° C. and at a load of 2.16 kg. The fibers generally have a length of less than about 30 mm, such as less than about 15 mm, such as less than about 10 mm, such as less than about 8 mm, such as less than about 6 mm.

The polyoxymethylene fibers may comprise microfibers and can have a size of less than about 20 denier, such as less than about 10 denier, such as less than about 5 denier, such as less than about 3 denier.

The fibers can be coated with a sizing composition. The sizing composition can contain a sizing agent in combination with at least one of a lubricant, an emulsifier, and/or an anti-static agent. In one embodiment, the sizing agent comprises a hydrophilic silicone. In an alternative embodiment, the sizing agent comprises a silane. In still another embodiment, the sizing agent may comprise an alkoxylated alcohol.

In still other embodiments, the sizing agent may comprise an alkoxylated ester, an alkyl ethoxylate, an alkyl phenyl ethoxylate, an ethoxylated polycarboxylate, a polyether carboxylate, a fatty acid alcohol, a fatty acid ester, a fatty acid polyglycolester, an ethylene oxide copolymer, a propylene oxide copolymer, an alkyl terminated dimethylsiloxane, a hydroxyl terminated dimethylsiloxane, a polysaccharide, a modified starch derivative, a cellulosic derivative, a carboxymethyl cellulose, a methyl cellulose, a cellulose acetate, a polyvinyl alcohol derivative, a polyacrylate, a polyacrylic acid ester, a polyacrylic acid copolymer, a polyacrylic acid terpolymer, a polyester, a polyurethane derivative, a polyisocyanate derivative, a maleic acid copolymer, an ethylene vinyl acetate copolymer, a vinyl acetate ethylene copolymer, or a vinyl versatate copolymer.

The resulting construction material once cured can have improved physical properties. For instance, the construction material can have a flexural strength of greater than about 600 psi, such as greater than about 625 psi, can have a residual strength of greater than about 180 psi, such as greater than about 190 psi, can have an impact resistance of greater than about 45 repeated blows with an impact drop weight of 10 lbs, such as greater than about 48 repeated blows with an impact drop weight of 10 lbs, and can have a compressive strength of greater than about 5100 psi.

Other features and aspects of the present disclosure are discussed in greater detail below.

### BRIEF DESCRIPTION OF THE DRAWINGS

A full and enabling disclosure of the present disclosure, including the best mode thereof, to one of ordinary skill in the art, is set forth more particularly in the remainder of the specification, including reference to the accompanying figures in which:

FIG. 1 schematically illustrates one method for forming a fiber as described herein; and

FIG. 2 are graphical representations of results described in the examples below.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to polyoxymethylene fibers well suited for incorporation into construction materials. The present disclosure is also directed to improved construction materials containing the polyoxymethylene fibers.

In one embodiment, the present disclosure is directed to a construction material that includes a plurality of discrete polyoxymethylene fibers randomly distributed throughout the matrix. In one embodiment, the polyoxymethylene fibers have a relatively short length, such as less than about 30 mm, such as less than about 15 mm, such as less than about 10 mm, such as less than about 8 mm, such as even less than about 6 mm. The fibers are generally longer than about 1 mm. The fibers may comprise microfibers. In an alternative embodiment, however, macrofibers may be used. In still another embodiment, the construction material may include a combination of microfibers and macrofibers.

In accordance with the present disclosure, the fibers are coated with a sizing composition. The sizing composition improves the dispersibility and storage stability of the polyoxymethylene fibers in the construction material in dry form. The sizing composition also improves the workability, flowability, and slump control of the construction material when mixed with water. The sizing composition also improves the properties of the construction material after hardening and curing. For instance, the use of the sizing composition can reduce shrinkage and crack width. The sizing composition can increase flexural strength, residual strength, toughness, impact resistance, compressive strength, and fire resistance, in comparison to an identical construction material containing polyoxymethylene fibers not coated with the sizing composition. The polyoxymethylene fibers can mix well with wet construction materials and resist surface blooming during set. In one embodiment, polyoxymethylene copolymers utilized to form the fibrous additives can include one or more chemical groups, e.g., end groups and/or pendant groups that can further improve integration of the fibrous additives formed of the polymer with the wet construction material. Chemical groups encompassed herein include groups that can increase the polarity of the polyoxymethylene and increase the hydrophilicity of the formed fibers, which can improve miscibility of the fibers in wet slurries and pastes. Also encompassed herein are chemical groups that can bond with components of the construction material or can hydrolyze to form groups that can bond with components of the construction material, e.g., form covalent or noncovalent (e.g., electrostatic or ionic) bonds with one or more components of the hydraulic binder, so as to further improve strength characteristics.

The fibers can be produced from a polymer composition containing a polyoxymethylene polymer. The composition may contain only a polyoxymethylene polymer or may contain a polyoxymethylene polymer in combination with other polymers, such as a thermoplastic elastomer.

The polyoxymethylene polymer used in the polymer composition may comprise a homopolymer or a copolymer. The polyoxymethylene polymer generally contains a relatively high amount of functional groups, such as hydroxyl groups in the terminal positions. More particularly, the polyoxymethylene polymer can have terminal hydroxyl groups, for example hydroxyethylene groups and/or hydroxyl side groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 5 mmol/kg, such as at least 10 mmol/kg, such as at least 15 mmol/kg, such as at least 20 mmol/kg, such as at least 25 mmol/kg. In one embodiment, the terminal hydroxyl group content ranges from 18 to 500 mmol/kg, such as from about 25 mmol/kg to about 400 mmol/kg.

In addition to the terminal hydroxyl groups, the polyoxymethylene polymer may also have other terminal groups usual for these polymers. Examples of these are alkoxy groups, formate groups, acetate groups or hemiacetal groups. According to one embodiment, the polyoxymethylene is a homo- or copolymer which comprises at least 50 mol-%, such as at least 75 mol-%, such as at least 90 mol-% and such as even at least 97 mol-% of —CH2O-repeat units.

The polyoxymethylene polymer can have any suitable molecular weight. In one embodiment, however, a relatively low molecular weight polymer may be used. The molecular weight of the polymer, for instance, can be from about 4,000 grams per mole to about 20,000 grams per mole. In other embodiments, however, the molecular weight can be well above 20,000 grams per mole, such as from about 20,000 moles per gram to about 100,000 grams per mole.

The preparation of the polyoxymethylene can be carried out by polymerization of polyoxymethylene-forming monomers, such as trioxane or a mixture of trioxane and a cyclic acetal such as dioxolane in the presence of ethylene glycol as a molecular weight regulator.

In one embodiment, a polyoxymethylene copolymer is used. A polyoxymethylene copolymer can be formed from polymerization of one or more monomers that can produce on the copolymer terminal groups that can provide desirable characteristics to the fibrous concrete additives formed of the polyoxymethylene copolymers. For example, a copolymer can be formed so as to include terminal and/or pendant groups including, without limitation, alkoxy groups, formate groups, acetate groups and/or aldehyde groups. The terminal groups can be functional as formed, e.g., the terminal groups of the as-formed polymer can increase hydrophilicity of the polyoxymethylene copolymer and/or can provide bonding sites for bonding with one or more components of the concrete. Alternatively, the formed copolymer can be further treated to form terminal groups useful in the formed concrete additives. For example, following formation, the copolymer can be subjected to hydrolysis to form the desired terminal groups on the copolymer.

Without wishing to be bound to any particular theory, it is believed that the formation of additional reactive terminal groups (i.e., end groups and pendant groups) on a polyoxymethylene polymer can encourage bond formation between the polyoxymethylene copolymer and components of the hydraulic binder. For instance, Portland cement is a complex mixture of di- and tricalcium silicates, tricalcium aluminate, and a smaller amount of a ferrite phase. Accordingly, the hydroxyl groups of a polymer can bond —Si—OH, Al—OH, and Fe—OH moieties of a Portland cement. Similar binding can take place with other binders as are known in the art.

The copolymer can contain from about 0.1 mol % to about 20 mol % and in particular from about 0.5 mol % to about 10 mol % of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

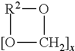

in which x is 0 or 1 and R2 is a C2-C4-alkylene group which, if appropriate, has one or more substituents which are C1-C4 -akyl groups, or are C1-C4-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers.

It is particularly advantageous to use copolymers composed of from 99.5 to 95 mol % of trioxane and of from 0.5 to 5 mol % of one of the above-mentioned comonomers.

The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted.

In one embodiment, a polyoxymethylene polymer with hydroxyl terminal groups can be produced using a cationic polymerization process followed by solution hydrolysis to remove any unstable end groups. During cationic polymerization, a glycol, such as ethylene glycol can be used as a chain terminating agent. The cationic polymerization results in a bimodal molecular weight distribution containing low molecular weight constituents. In one particular embodiment, the low molecular weight constituents can be significantly reduced by conducting the polymerization using a heteropoly acid such as phosphotungstic acid as the catalyst. When using a heteropoly acid as the catalyst, for instance, the amount of low molecular weight constituents can be less than about 2% by weight.

The polyoxymethylene polymer present in the composition can generally have a melt volume rate (MVR) or melt index of less than 50 cm3/10 min, such as from about 1 to about 40 cm3/10 min, determined according to ISO 1133 at 190° C. and 2.16 kg. In general, the molecular weight of the polyoxymethylene polymer is related to the melt index. In particular, a higher melt index refers to a lower molecular weight. In one embodiment of the present disclosure, a polyoxymethylene polymer is incorporated into the polymer composition having a relatively low molecular weight.

In one embodiment, the polyoxymethylene polymer may have a meltflow rate of greater than about 7 g/10 min, such as greater than about 8 g/10 min. In an alternative embodiment, however, a polyoxymethylene polymer may be used that has a relatively low melt flow rate. For instance, the meltflow rate of the polymer can be less than about 5 g/10 min, such as less than about 3 g/10 min.

The amount of polyoxymethylene polymer present in the polymer composition of the present disclosure can vary depending upon the particular application. In one embodiment, for instance, the composition contains polyoxymethylene polymer in an amount of at least 50% by weight, such as in an amount greater than about 60% by weight, such as in an amount greater than about 65% by weight, such as in an amount greater than about 70% by weight. In general, the polyoxymethylene polymer is present in an amount less than about 99% by weight, such as in an amount less than about 95% by weight, such as in an amount less than about 90% by weight.

In one embodiment, the polymer composition may contain a polyoxymethylene polymer combined with a thermoplastic elastomer and optionally a coupling agent.

Thermoplastic elastomers are materials with both thermoplastic and elastomeric properties. Thermoplastic elastomers include styrenic block copolymers, polyolefin blends referred to as thermoplastic olefin elastomers, elastomeric alloys, thermoplastic polyurethanes, thermoplastic copolyesters, and thermoplastic polyamides.

Thermoplastic elastomers well suited for use in the present disclosure are polyester elastomers (TPE E), thermoplastic polyamide elastomers (TPE A) and in particular thermoplastic polyurethane elastomers (TPE-U). The above thermoplastic elastomers have active hydrogen atoms which can be reacted with the coupling reagents and/or the polyoxymethylene polymer. Examples of such groups are urethane groups, amido groups, amino groups or hydroxyl groups. For instance, terminal polyester diol flexible segments of thermoplastic polyurethane elastomers have hydrogen atoms which can react, for example, with isocyanate groups.

In one particular embodiment, a thermoplastic polyurethane elastomer is used either alone or in combination with other elastomers. The thermoplastic polyurethane elastomer, for instance, may have a soft segment of a long-chain diol and a hard segment derived from a diisocyanate and a chain extender. In one embodiment, the polyurethane elastomer is a polyester type prepared by reacting a long-chain diol with a diisocyanate to produce a polyurethane prepolymer having isocyanate end groups, followed by chain extension of the prepolymer with a diol chain extender. Representative long-chain diols are polyester diols such as poly(butylene adipate)diol, poly(ethylene adipate)diol and poly(c-caprolactone)diol; and polyether diols such as poly(tetramethylene ether)glycol, poly(propylene oxide)glycol and poly(ethylene oxide)glycol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate). Suitable chain extenders are C2-C6 aliphatic diols such as ethylene glycol, 1,4-butanediol, 1,6-hexanediol and neopentyl glycol. One example of a thermoplastic polyurethane is characterized as essentially poly(adipic acid-co-butylene glycol-co-diphenylmethane diisocyanate).

When a thermoplastic elastomer is present in the polymer composition the amount added to the composition can vary depending on various factors. For instance, the amount of thermoplastic elastomer incorporated in to the composition, can depend on the size of fibers that are desired. For instance, when producing smaller diameter fibers, in one embodiment, it may be preferable to add lesser amounts of the thermoplastic elastomer. For example, in one embodiment, when producing fibers having a diameter of about 0.2 mm or less, the thermoplastic elastomer may be present in an amount from about 0.5% to less than 5%, such as from about 1% to about 4.5%, such as from about 2% to about 4% by weight.

The coupling agent present in the polymer composition comprises a coupling agent capable of coupling the polyoxymethylene polymers together or with other components. In order to form bridging groups between the polyoxymethylene polymer and the elastomer, a wide range of polyfunctional, such as trifunctional or bifunctional coupling agents, may be used. The coupling agent may be capable of forming covalent bonds with the terminal hydroxyl groups on the polyoxymethylene polymer and with active hydrogen atoms on the thermoplastic elastomer. In this manner, the elastomer becomes coupled to the polyoxymethylene through covalent bonds.

In one embodiment, the coupling agent comprises a diisocyanate, such as an aliphatic, cycloaliphatic and/or aromatic diisocyanate. The coupling agent may be in the form of an oligomer, such as a trimer or a dimer.

In one embodiment, the coupling agent comprises a diisocyanate or a triisocyanate which is selected from 2,2′-, 2,4′-, and 4,4′-diphenylmethane diisocyanate (MDI); 3,3′-dimethyl-4,4′-biphenylene diisocyanate (TODD; toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis(isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

In one embodiment, an aromatic polyisocyanate is used, such as 4,4′-diphenylmethane diisocyanate (MDI).

The polymer composition generally contains the coupling agent in an amount from about 0.1% to about 10% by weight. In one embodiment, for instance, the coupling agent is present in an amount greater than about 0.5% by weight, such as in an amount greater than 1% by weight. In one particular embodiment, the coupling agent is present in an amount from about 0.2% to about 5% by weight. To ensure that the elastomer has been completely coupled to the polyoxymethylene polymer, in one embodiment, the coupling agent can be added to the polymer composition in molar excess amounts when comparing the reactive groups on the coupling agent with the amount of terminal hydroxyl groups on the polyoxymethylene polymer.

A formaldehyde scavenger may also be included in a polymeric composition. The formaldehyde scavenger, for instance, may be amine-based and may be present in an amount less than about 1% by weight.

A polymeric composition can optionally contain a stabilizer and/or various other known additives. Such additives can include, for example, viscosity reducing agents, antioxidants, acid scavengers, UV stabilizers or heat stabilizers, adhesion promoters, lubricants, nucleating agents, demolding agents, fillers, reinforcing materials or antistatic agents and additives which impart a desired property to the material, such as dyes and/or pigments.

In general, other additives can be present in the polymeric composition in an amount up to about 10% by weight, such as from about 0.1% to about 5% by weight, such as from about 0.1 to about 2% by weight.

The components of the polymeric composition can be melt blended together. In one embodiment, melt blending of the components can cause reaction to occur between individual components, such as a coupling agent, a polyoxymethylene polymer, and an impact modifier. Reaction between components can occur simultaneously or in sequential steps.

In one embodiment, the different components can be melted and mixed together in a conventional single or twin screw extruder. The melt blending of the components is typically carried out at temperatures of from about 100° C. to about 240° C., such as from about 150° C. to about 220° C., and the duration of mixing is typically from about 0.5 to about 60 minutes.

Following formation, the polymeric composition can be used as formed to prepare a fibrous additive for a construction material or may be formed for later processing. For instance, extruded strands may be produced by an extruder which are then pelletized and stored for later use. Prior to compounding, the polymer components may be dried to a moisture content of about 0.05 weight percent or less. If desired, the pelletized compound can be ground to any suitable particle size, such as in the range of from about 100 microns to about 500 microns.

Manufacturing processes for forming fibers from the polyoxymethylene generally need not vary with the specific polyoxymethylene copolymers utilized in forming the composition, e.g., POM, POM-OH or lateral-OH POM.

For purposes of this disclosure, multifilament fiber is herein defined to refer to a fiber that has been extruded or spun from a melt as an individual fiber. That is, while the extruded multifilament fiber can be subjected to post-extrusion processing (e.g., quenching, drying, drawing, heat processing, finish application, texturing, chopping, etc.), the fiber will be initially extruded or spun from a melt in the individual fiber form. A tape fiber, on the other hand, is intended to refer to fibers that have been formed from a larger section during post-extrusion processing. For example, the term ‘tape fiber’ can encompass fibers that have been cut or otherwise separated from a larger extruded film, for instance an extruded flat film or a film extruded as a cylinder. In general, tape fibers can have a clear delineation between adjacent sides of the fibers, with a clear angle between the adjacent sides, as they can usually be formed by cutting or slicing individual fibers from the larger polymer section, but this is not a requirement. For example, in one embodiment, individual tape fibers can be pulled from a larger polymeric piece, and thus may not show the sharper angles between adjacent edges that may be common to a tape fiber that has been cut from a larger piece of material.

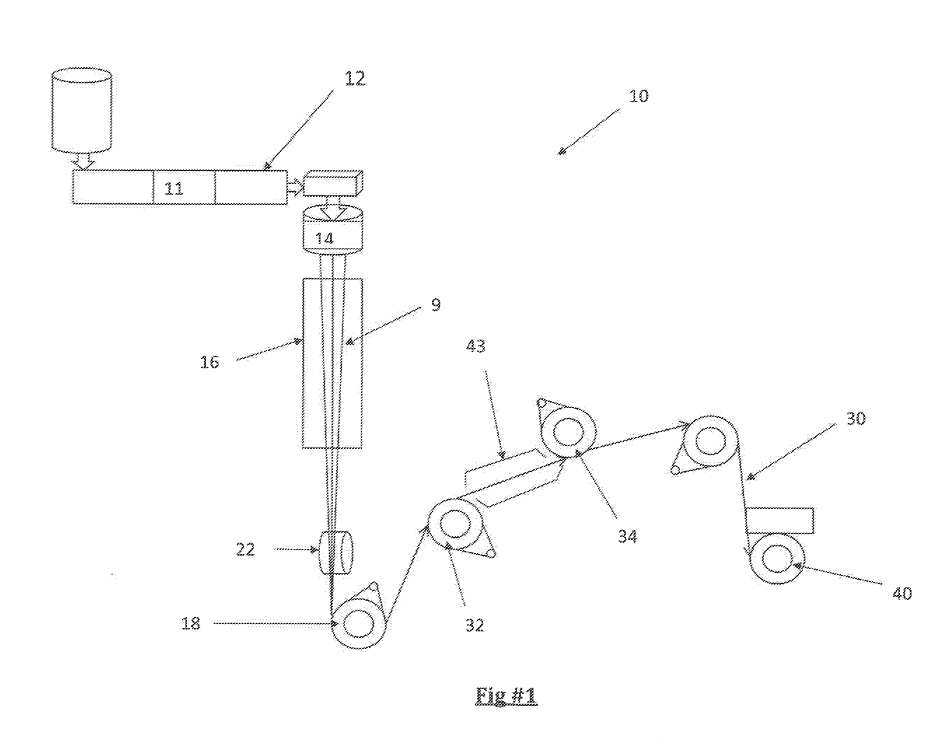

Referring to FIG. 1, one embodiment of a polyoxymethylene fiber forming process generally 10 is schematically illustrated. According to the illustrated embodiment, a melt of a polyoxymethylene composition can be provided to an extruder apparatus 12.

The extruder apparatus 12 can be a melt spinning apparatus as is generally known in the art. For example, the extruder apparatus 12 can include a mixing manifold 11 in which a polyoxymethylene composition can be mixed and heated to form a molten composition. The formation of the molten mixture can generally be carried out at a temperature as described above, e.g., from about 100° C. to about 240° C.

Optionally, to help ensure the fluid state of the molten mixture, in one embodiment, the molten mixture can be filtered prior to extrusion. For example, the molten mixture can be filtered to remove any fine particles from the mixture with a filter of between about 180 and about 360 gauge.

Following formation of the molten mixture, the mixture can be conveyed under pressure to the spinneret 14 of the extruder apparatus 12, where it can be extruded through an orifice to form the fibers 9. The mixture can be extruded as either a multifilament fiber 9, as shown in FIG. 1, or as a film, for instance in either a sheet orientation or in a cylindrical orientation, and cut or sliced into individual tape fibers during post-processing of the film. In particular, while the majority of the ensuing discussion is specifically directed to the formation of a multifilament fibers, it should be understood that the below described processes are also intended to encompass the formation of a film for subsequent formation of a tape fiber.

The spinneret 14 can generally be heated to a temperature that can allow for the extrusion of the molten polymer while preventing breakage of the fiber 9 during formation. For example, in one embodiment, the spinneret 14 can be heated to a temperature of between about 125° C. and about 210° C. In one embodiment, the spinneret 14 can be heated to the same temperature as the mixing manifold 11. This is not a requirement of the process, however, and in other embodiments, the spinneret 14 can be at a different temperature than the mixing manifold 11. For example, in one embodiment, increasing temperatures can be encountered by the mixture as it progresses from the inlet to the mixing manifold to the spinneret. In one embodiment, the mixture can progress through several zones prior to extrusion.

When forming multifilament fibers, the spinneret orifice through which the polymer can be extruded can generally be less than about 2.5 mm in maximum cross-sectional width (e.g., diameter in the particular case of a circular orifice). For example, in one embodiment, when forming a macrofiber, the spinneret orifices can be between about 1 mm and about 2.5 mm in maximum cross-sectional width. When forming a microfiber, the spinneret orifices can be between about 0.2 mm and about 1.5 mm in maximum cross-sectional width.

When forming a film, the film die can be of any suitable orientation and length, and can be set to a thickness of less than about 2.5 mm. For example, in one embodiment, the film die can be set at a width of between about 1 mm and about 2.5 mm.

Following extrusion of the polymer, the un-drawn fiber 9 can be quenched, for instance in a fiber attenuation box 16 and directed by roll 18. The fiber attenuation box 16 in which the fibers 9 can be quenched can be a fluid in which the polymer is insoluble. For example, the fluid can be air, water mist, steam or any other suitable fluid as is generally known in the art. Generally, in order to encourage formation of fibers with substantially constant cross-sectional dimensions along the fiber length, excessive agitation of the bath 16 can be avoided during the process. Of course, a quench fluid is not a requirement of disclosed processes, and in another embodiment, the un-drawn fiber can be quenched in a liquid bath, as is known.

According to another embodiment, the extruded fiber can be quenched according to an air cooling procedure. According to this embodiment, an extruded fibers can be carried out under an air flow at a pre-determined temperature, for instance between about 30° C. and about 80° C., or about 50° C. in one embodiment.

In one embodiment, a lubricant can be applied to the fibers 9. For example, a spin finish can be applied at a spin finish applicator roll 22, as is generally known in the art. In general, a lubricant can be applied to the fibers 9 at a low water content. For example, a lubricant can be applied to the fibers 9 when the fibers are at a water content of less than about 75% by weight. Any suitable lubricant can be applied to the fibers 9. For example, a suitable oil-based finish can be applied to the fibers 9, such as Silastol TC2, available from Schill+Seilacher GmbH. Addition of a finishing or lubricant coat on the fiber can, in some embodiments, improve handling of the fibers during subsequent processing and can also reduce friction and static electricity build-up on the fiber.

After quenching of the fibers 9 and any optional process steps, such as addition of a lubricant for example, the fibers can be drawn while applying heat. For example, in the embodiment illustrated in FIG. 1, the fibers 9 can be drawn in an oven 43 heated to a temperature of between about 100° C. and about 175° C. Additionally, in this embodiment, the draw rolls 32, 34 can be either interior or exterior to the oven 43, as is generally known in the art. In another embodiment, rather than utilizing an oven as the heat source, the draw rolls 32, 34 can be heated so as to draw the fibers while it is heated. For example, the draw rolls can be heated to a temperature of between about 60° C. and about 160° C. In another embodiment, the fibers can be drawn over a hotplate heated to a similar temperature or by passing through a heated liquid bath.

The fibers can be drawn in a first (or only) draw at a high draw ratio. For example, the fibers 9 can be drawn with a draw ratio (defined as the ratio of the speed of the second or final draw roll 34 to the first draw roll 32) of greater than about 3. For instance, in one embodiment, the draw ratio of the first (or only) draw can be greater than about 4. In another embodiment, the draw ratio can be up to about 10. Additionally, the fibers can be wrapped on the rolls 32, 34 as is generally known in the art. For example, in one embodiment, between about 5 and about 15 wraps of the fiber can be wrapped on the draw rolls.

A multi-stage draw can optionally be utilized. For instance, in a two stage draw, a fiber can be drawn to about 3 to about 15 times the original length in a first stage at a temperature of between about 60° C. and about 160° C., or between about 120° C. and about 150° C. in another embodiment. In a second stage draw, the fiber can be drawn from about 1.05 to about 6 times the length of the fiber following the first stage draw, or from about 1.05 to about 2 times the length of the fiber following the first stage draw in another embodiment. The second draw can generally be carried out at a temperature that is higher than the temperature of the first stage draw, for example between about 100° C. and about 165° C., or from about 150° C. to about 160° C. in another embodiment.

Multi-stage drawing processes can be carried out in similar or different environments. For instance, a first stage draw can be carried out in a heated oven, and a second stage can be carried out in a heated liquid bath. Multi-stage draws can include two, three, or higher numbers of stages can be utilized. In one embodiment, a three stage draw can be used in which the fiber can be subjected to a first draw in air, a second draw in a heated aqueous bath and a third draw in a heated organic solution (e.g., an oil).

While the embodiment of FIG. 1 utilizes a series of draw rolls for purposes of drawing the fiber, it should be understood that any suitable process that can place a force on the fiber so as to elongate the fiber following the quenching step can optionally be utilized. For example, any mechanical apparatus including nip rolls, godet rolls, steam cans, air, steam, or other gaseous jets can optionally be utilized to draw the fiber. Filament extrusion and drawing can be performed in two independent steps or extrusion followed by drawing in a single step.

Following the drawing step, the drawn fibers 30 can be cooled and wound on a take-up roll 40. In other embodiments, however, additional processing of the drawn fibers 30 may be carried out.

Optionally, the drawn fibers can be heat set. For example, the fibers can be relaxed or subjected to a very low draw ratio (e.g., a draw ratio of between about 0.7 and about 1.3) and subjected to a temperature of between about 140° C. and about 170° C. for a short period of time, generally less than about 3 minutes. In some embodiment, a heat setting step can be less than one minute, for example, about 0.5 seconds. This optional heat set step can serve to “lock” in the crystalline structure of the fibers following drawing. In addition, it can reduce heat shrinkage.

In an embodiment in which a film is formed at the extruder, a tape fiber can be formed from the film either before or after the draw step, as desired. For example, in one embodiment the film can be subjected to a drawing step, and the drawn film can be further processed to form the tape fibers of the present invention. In another embodiment, the film can be processed to form the tape fibers first, and then the formed fibers can be drawn, as described above for a monofilament fiber. In either case, the tape fibers can be cut or formed from the film according to any process as is generally known in the art including, for example, use of metal blades, rotary knives, and the like.

The fibers produced by the above process can have any suitable cross-sectional shape. For example, the fibers can be circular or can be non-circular. Split-film fibers, for instance, may have a rectangular shape cross-section. Other possible cross-sectional shapes include elliptical or multi-lobal cross-sections.

The size of the fibers can also vary depending upon the particular application. In one embodiment, for instance, microfibers can be produced having a size of less than about 20 denier, such as less than about 10 denier, such as less than about 5 denier, such as less than about 3 denier. In general, the size of the fibers is greater than about 0.1 denier, such as greater than about 1 denier.

In other embodiments, the fibers may comprise macrofibers. For example, the fibers may have a size of greater than about 500 denier, such as greater than about 700 denier, such as greater than about 1000 denier. The macrofibers can have a size of less than about 4000 denier, such as less than about 3000 denier, such as less than about 2000 denier.

After the fibers are produced, the fibers can be cut to any suitable length. In one embodiment, relatively short fibers are incorporated into the construction material. For instance, the fibers can have a length of less than about 30 mm, such as less than about 15 mm, such as less than about 10 mm, such as less than about 8 mm, such as less than about 6 mm. In general, the fibers have a length greater than about 1 mm, such as greater than about 2 mm.

In accordance with the present disclosure, prior to or after cutting or chopping the fibers, the fibers are treated with a sizing composition. The sizing composition contains a sizing agent optionally in combination with an emulsifying agent, a wetting agent, a dispersing agent, an anti-static agent, a lubricating agent, and/or a defoaming agent. The sizing composition may be a liquid, an emulsion, a dispersion, or a powder. As explained above, in one embodiment, the sizing composition can be applied to the fibers after they are formed. In other embodiments, however, the sizing composition may be compounded with the polyoxymethylene polymer before it is spun into a fiber. For example, if the sizing composition comprises a powder, the powder may be combined with the polyoxymethylene resin as the resin is fed to an extruder or may be precompounded with the resin. The sizing chemicals can be applied at multiple locations during the fiber manufacturing process for example after the fiber attenuation box, before winding, before cutting, or compounded in the resin. Multiple combinations of sizing chemicals and application locations can be used.

Various different types of sizing agents may be used in accordance with the present disclosure. The sizing composition, for instance, may contain one or more of the following sizing agents:

a) alkoxylated alcohols, alkoxylated esters, alkyl ethoxylates, alkyl phenyl ethoxylates, ethoxylated alcohols, ethoxylated polycarboxylates, polyether carboxylates, alcohols and esters derived from fatty acids, fatty acid polyglycolesters

b) ethylene oxide—propylene oxide copolymers

c) silanes, amino silanes, and aminoalkylalkoxysilanes such as 3-Aminopropyltrimethoxysilane

d) silicone additives, alkyl terminated dimethylsiloxanes, hydroxyl terminated dimethylsiloxanes

e) polysaccharides and modified starch derivatives

f) cellulosic derivatives: carboxymethylcellulose, methylcellulose, cellulose acetate

g) polyvinyl alcohol derivatives

h) polyacrylates, polyacrylic acid esters including ethoxylates and ethoxylate-propoxylate, and polyacrylic acid copolymers and terpolymers

i) polyester, polyurethane and polyisocyanate derivatives

j) maleic acid copolymers

k) ethylene vinyl acetate and vinyl acetate ethylene copolymers, vinyl versatate copolymers.

In one particular embodiment, the sizing agent may comprise a hydrophilic silicone. The silicone can be combined with a lubricant, an emulsifier, and an anti-static agent. In one embodiment, the silicone may comprise 3-Aminopropyltrimethoxysilane.

In an alternative embodiment, the sizing agent may comprise an ethoxylated alcohol. The alcohol, for instance, can be a linear alcohol. The alcohol can have a carbon chain length of from about 4 carbon atoms to about 38 carbon atoms. For instance, the alcohol can have a carbon chain length of greater than about 8 carbon atoms, such as greater than about 10 carbon atoms, such as greater than about 12 carbon atoms. The carbon chain length of the alcohol can generally be less than about 36 carbon atoms, such as less than about 28 carbon atoms.

The sizing composition improves the dispersion of the polyoxymethylene fibers in the construction material. It was unexpectedly discovered that the sizing composition can actually improve the physical properties of the resulting material as well.

Once the fibers are formed and treated with a sizing composition, the fibers are incorporated into a construction material. The polyoxymethylene fibers are randomly distributed throughout the construction material. As described above, the polyoxymethylene fibers may comprise microfibers, macrofibers, or may comprise a combination of microfibers and macrofibers.

The construction material can include a binder alone or may comprise a binder and aggregate. The aggregate may comprise a quartz sand or calcium carbonate, or other suitable aggregate. The binder may include, for instance, Portland cement or gypsum. A construction material may comprise readymix and precast concrete, structural concrete, self-leveling concrete, self-compacting concrete, ultra-high performance concrete, shotcrete, Portland cement, aluminate cement, or mixtures thereof with fine or coarse aggregates. The construction material may include plasticizers and other additives. Other construction materials include industrial drymix mortars, ceramic tile adhesive, ceramic tile grouts, renders and plasters, external thermal insulation systems, flooring products such as self-leveling underlayments and overlayments, technical mortars, concrete repair mortars, anchoring grouts, downhole cementing products, gypsum products, drywall, and the like.

As described above, in one embodiment, the aggregate may contain calcium carbonate that can be obtained from different sources, such as limestone. The calcium carbonate can be present in the aggregate or in the construction material in an amount greater than about 30% by weight, such as in an amount greater than about 40% by weight, such as in an amount greater than about 50% by weight, such as in an amount greater than about 60% by weight, such as in an amount greater than about 70% by weight, such as in an amount greater than about 80% by weight. The amount of calcium carbonate contained in the aggregate or in the construction material is generally less than about 90% by weight, such as generally less than about 85% by weight, such as generally less than about 80% by weight, such as generally less than about 75% by weight. In one particular embodiment, for instance, the construction material may contain calcium carbonate in an amount from about 60% to about 70% by weight.

In one embodiment, the construction material may include iron or steel reinforcing elements, such as bars or rods. The steel bars or rods may be considered a primary reinforcement in the construction material, while the polyoxymethylene fibers may be considered a secondary reinforcement.

Traditional concrete generally has a density of between about 2000 kilogram per cubic meter (kg/m³) and about 2500 kg/m³. Foamed concrete is also encompassed by the term. Foamed concrete incorporates a foaming agent during the formation process and is much lighter than traditional concrete, generally having a density of between about 400 kg/m³ and about 1600 kg/m³. The term ‘concrete’ encompasses, without limitation, hydratable compositions including ready-mix or pre-cast concrete, masonry concrete, shotcrete, bituminous concrete, gypsum compositions, cement-based fireproofing compositions, and the like.

The binder can be present in the composition in an amount greater than about 5% by weight, or greater than about 20% by weight. In one embodiment, the binder can be present in an amount up to about 50%, or up to 80% by weight. When describing the cementitious composition, the above percentages by weight are based upon the weight percentage of dry material and thus excludes water if present in the product.

Polyoxymethylene fibrous additives can be added at relatively low loading levels and can provide significant improvement to construction material. For instance, polyoxymethylene macrofibers can be added at a level up to about 8 lb/yd³, or up to about 5 lb/yd³ in one embodiment, or greater than about 2 lb/yd³, or greater than about 3 lb/yd³. Polyoxymethylene microfibers can generally be added at lower loading levels than polyoxymethylene macrofibers. For instance, polyoxymethylene microfibers can be added at a level up to about 3 lb/yd³, or up to about 2 lb/yd³ in one embodiment, or greater than about 1 lb/yd³, or greater than about 0.5 lb/yd³

Polyoxymethylene fibrous additives can be blended with wet materials while considering several variables including temperature, time, concentration, type of material, and the like, according to known practices so as to obtain a composite including the fibers randomly distributed throughout the composite with little or no agglomeration. Generally, a predetermined amount of polyoxymethylene fibrous additives can be added to a construction material during the regular mixing phase of the preparation. For instance, polyoxymethylene fibrous additives can be added to the construction material, or a component of the material, either in a dry-phase addition or a wet-phase addition.

In a dry-phase addition, polyoxymethylene fibrous additives can be added and mixed with the aggregate or the dry material prior to mixing with water. In a wet-phase process, polyoxymethylene fibrous additives can be added to the wet component, generally at ambient temperature, prior to combination with an aggregate if present.

In general, the construction material can contain any suitable aggregate. Aggregates that may be used include, for instance, quartz sand, calcium carbonate, talc, dolomite, aluminum silicates, mica, pumice, perlites, vermiculites, and mixtures thereof. Aggregate can generally be present in the cementitious composition in an amount from about 10% to about 90% by weight, such as from about 40% to about 90% by weight, such as from about 60% to about 80% by weight.

The construction material can be formed with additional modifiers as are generally known in the art. For instance, in addition to the polyoxymethylene fibers, additional fibers such as glass fibers, steel fibers, natural fibers, and polymeric fibers including polyolefins, polyamides (e.g., nylon), and so forth can be incorporated in the material. Other modifiers include mesh, rebar, cellulose ethers, and the like.

Standard mixing times as are known in the art can be utilized. However, mixing times can vary greatly, as is known, for instance from about five minutes to well over an hour, depending on local conditions, specific materials, and so forth. Thorough mixing of the materials can randomly distribute the polyoxymethylene fibrous additives throughout the composition with little or no agglomeration of the fibers in the binder.

Following mixing and lying of the construction material, the material can set according to standard processes.

Treating the polyoxymethylene fibers with a sizing composition in accordance with the present disclosure provides many benefits and advantages. In addition to improving the dispersibility of the fibers, which is typically the reason a sizing composition is used, the present inventors unexpectedly discovered that the sizing composition can dramatically improve various properties of the resulting cured construction material. These improved properties include reduced shrinkage, reduced crack width, increased flexural strength, increased residual strength, increased toughness, increased impact resistance, increased compressive strength, and increased fire resistance. For instance, a construction material made in accordance with the present disclosure after 28 days of curing can have a flexural strength of greater than about 600 psi, such as greater than about 625 psi (and generally less than about 1000 psi). The construction material may have a residual strength of greater than about 180 psi, such as greater than about 190 psi (and generally less than about 400 psi). The impact resistance of the construction material may be able to withstand at least 45 repeated blows with an impact drop load of 10 lbs, such as at least 48 repeated blows (and generally less than about 90 repeated blows). The construction material can have a compressive strength of from about 5100 psi to about 7000 psi, such as from about 5200 psi to about 6000 psi.

The present disclosure may be better understood with reference to the examples below.

In the examples below, polyoxymethylene fibers were produced from the polymerization of trioxane with 1,3-dioxolane and using an ethylene glycol chain transfer agent.

The fibers were of 5 to 6 denier, with cut lengths of 3 millimeters and 6 millimeters. In the examples below, the polyoxymethylene fibers were either left untreated or treated with a sizing composition in accordance with the present disclosure. The following sizing compositions were used:

TABLE 1

| Sizing ID | Description |
|---|---|
| Sizing 1 | Based on 3-Aminopropyltrimethoxysilane |
| Sizing 2 | Based on a silicone additive and |
| | 3-Aminopropyltrimethoxysilane |
| Sizing 3 | Based on ethoxylated alcohol |
| Sizing 4 | Based on hydrophilic silicone mixed with lubricants, |
| | emulsifiers, antistats |

### EXAMPLE 1

The following example demonstrates the improved dispersion of polyoxymethylene fibers in a construction material.

All fibers were 6 mm cut length. All fibers were dried overnight at 80° C. under vacuum before use. In the dry dispersion test the dispersability of the fibers was assessed visually after storing a 500 g fiber sample for 15 days in standard storage conditions (23° C., 50% RH) in a laboratory. For the water dispersion test and dispersion test in dry mortar, 0.2 wt. % fiber was mixed in a 4.58 liter Hobart® rotating drum mixer with a typical batch size of approximately 2.0 to 3.0 liters for 30 s at speed 1. For the dispersion test in wet mortar i.e. freshly prepared mortar, the mixing procedure encompasses 30 s at speed 1 and 90 s at speed 2 in the same Hobart® mixer. For the dispersion test in hardened mortar, (i) at 0.2 wt. % and 0.5 wt. % fiber dosage the mixing procedure encompasses 30 s at speed 1 and 90 s at speed 2 in the same Hobart® mixer, (ii) 1 wt. % and 0.5 wt. % fiber dosage the mixing procedure encompasses 30 s at speed 1 and 270 s at speed 2 in the same Hobart® mixer. The mortar used is a self levelling compound Ardex® K15 from Ardex GmbH, Germany at a water drymix ratio of 0.25 wt. %. Quality of the fiber dispersion in the medium was assessed visually and performance ranked from excellent (9), good (6), poor (3), very poor (1).

TABLE 2

| | | | Dispersion | | Dispersion | Dispersion | | | |
|---|---|---|---|---|---|---|---|---|---|
| | | | test after | Water test | test in dry | test in wet | Dispersion test in | | |
| | | | drying | Dispersion | mortar | mortar | hardened mortar | | |
| | | | Fiber usage (wt. %) | | | | | | |
| Sample | Fiber Description | Sizing | 0.2 | 0.2 | 0.2 | 0.2 | 1.0 | 0.5 | 0.2 |
| 1 | Polyvinylalcohol | Proprietary | 3 | 6 | 6 | 6 | 3 | 6 | 6 |
| 2 | Polypropylene | Proprietary | 1 | 3 | 3 | 6 | 1 | 6 | 6 |
| 3 | Polyoxymethylene | None | 3 | 9 | 3 | 6 | 6 | 9 | 9 |
| 4 | Polyoxymethylene | Sizing 1 | 6 | 9 | 6 | 3 | 9 | 9 | 9 |
| 5 | Polyoxymethylene | Sizing 3 | 9 | 6 | 6 | 3 | 9 | 9 | 9 |
| 6 | Polyoxymethylene | Sizing 4 | 9 | 9 | 9 | 6 | 9 | 9 | 9 |

### EXAMPLE 2

The following example demonstrates the improved physical properties of a construction material that contains polyoxymethylene fibers made in accordance with the present disclosure and combined with a sizing composition.

The following mortar was combined with polyoxymethylene microfibers in the amount shown below.

TABLE 3
Materials and proportions for the mortar

| Materials | Proportions |
|---|---|
| Prepackaged self-levelling underlayment mortar | 250 lbs |
| (ChemRex-SLU, BASF Corp.) | |
| Water | 44 lbs |
| Microfibers | 1.25 lbs |

The mortar, water and fibers were mixed in a 6.0 ft³ rotating drum mixer with a typical batch size of approximately 2.0 to 3.0 ft³ following the procedure similar to the one described in ASTM C192. Water was first added to the mixer followed by the mortar. All materials were mixed for about 3 minutes and rested for 3 minutes. The fibers were then added to the mixture while the mixer was running until the fibers were evenly distributed. This typically took an additional 2 to 3 minutes. After mixing, the fresh mixture was transferred to a wheelbarrow and the specimens were prepared following the procedures given in ASTM C192.

After mixing, the mortar mixture was placed into the 4 inch×8 inch cylindrical plastic molds for the compressive strength testing and 4 inch×4 inch×14 inch metal molds for the flexural and the average residual strength testing. In addition, three 12 inch long and 6 inch diameter cylinders were prepared for each mortar mixture for the impact resistance test. After the placement, the mortar mixture was rodded, finished, covered with the plastic sheet for initial curing for 24 hours at the room temperature (73° F.), and then demolded. After demolding, the specimens were cured in the lime-saturated water until the time of testing, 28 days, for flexural strength, residual strength, toughness, and compressive strength. For impact resistance testing, two 2.5 inch disks were cut from the middle portion of each cylinder after 7 days curing and 28 days curing in lime saturated water.

Flexural strength was tested on three 4 inch×4 inch×14 inch beam specimens for each mortar/fiber formulation using a span length of 12 inches per ASTM C1609. The beam samples were tested using a Satec-Model 5590-HVL closed-loop, dynamic servo-hydraulic, testing machine conforming to the requirements of ASTM E4-07 “Standard Practices for Force Verification of Testing Machines”. Load and net deflection data were collected electronically at a frequency of 5 Hertz. The load was applied perpendicular to the molded surfaces after the edges were ground with a rubbing stone. Net deflection values, for both data acquisition and rate control, were obtained at the mid-span and mid-height of the beams. The rate was held constant at 0.002 in/min of average net deflection for the entire duration of each test.

The flexural strength of fiber reinforced mortar is shown in Table 4. The mortar reinforced with polyoxymethylene fiber that incorporated sizing had higher flexural strength than the control mortar, the mortar reinforced with polyoxymethylene fiber with no sizing, and the mortar reinforced with polyvinylalcohol fiber and polypropylene fiber.

Residual strength is an indication of the cementitious mortar's strength after cracking, which is achieved as a result of fiber-reinforcement. It is associated with the property of fibers, the quality of bond between the fiber and the matrix, as well as the length of bond. Average residual strength was tested as per ASTM C1399, the rate of testing for both the initial loading and re-loading was 0.025 in/min of crosshead displacement. Initial loading for all beam samples was terminated at 0.008 inches of average net deflection.

The residual strength of fiber reinforced mortar is shown in Table 4. Without the fiber addition, the control mortar had brittle failure after the crack initiated. Effectively, the control mortar samples had no residual strength. Fiber reinforced mortar formulations had residual flexural strength of more than 50 psi, which is above the minimum acceptance criteria in ICC-ES AC32, suggesting that these fibers can effectively hold concrete together after cracking.

The polyoxymethylene fiber reinforced mortar had higher residual strength than mortar reinforced with alkali resistant glass fiber, polyvinylalcohol fiber and polypropylene fiber. The mortar reinforced with polyoxymethylene fiber that used sizing had significantly higher residual strength than that when no sizing was used.

TABLE 4
Mechanical properties of microfiber reinforced mortar

| | | 28 days | 28 days | 28 days | | |
|---|---|---|---|---|---|---|
| | | compressive | flexural | residual | 28 days | 28 days |
| | | strength Rc | strength Rf | strength | Toughness | Rf/Rc |
| Microfiber Description | Sizing | (psi) | (psi) | (psi) | (lbs-in) | (%) |
| Control: No microfiber | Not applicable | 5023 | 600 | 0 | 0 | 11.9 |
| Alkali resistant glass | Proprietary | 5510 | 678 | 87 | 47 | 12.3 |
| Polyvinylalcohol | Proprietary | 4513 | 612 | 75 | 87 | 13.5 |
| Polypropylene | Proprietary | 4207 | 573 | 58 | 27 | 13.6 |
| Polyoxymethylene | None | 4500 | 542 | 174 | 67 | 12.0 |
| Polyoxymethylene | Sizing 1 | 5360 | 680 | 195 | 73 | 12.7 |
| Polyoxymethylene | Sizing 2 | 4700 | 630 | 203 | 68 | 13.4 |
| Polyoxymethylene | Sizing 3 | 4003 | 653 | 209 | 92 | 16.3 |
| Polyoxymethylene | Sizing 4 | 3987 | 640 | 226 | 83 | 16.1 |

Toughness measures the capacity of the construction material to absorb energy during fracture. A tougher construction material is always preferred because it helps to avoid the sudden failure of the structure. Toughness was calculated as the area under the flexural load-deflection curve up to the net deflection of 1/150 of the span. Table 4 provides the results of toughness for fiber-reinforced mortars and the control specimen.

The polyoxymethylene fibers helped to increase the toughness of mortar as compared with the control mortar. The mortar reinforced with polyoxymethylene fiber that incorporated sizing had higher toughness than mortar reinforced with a polyoxymethylene fiber with no sizing.

Impact resistance of cementitious mortar was assessed based on the procedure described in ICC-ES AC-32. Disk specimens 2.5 inches were cut from the middle portion of 12 inches long and 6 inches diameter cylinders. A hardened steel ball was dropped from a height of 18 inches above the disc to have an impact drop weight of 10 lbs. The number of repeated drops to cause failure was recorded. The test was conducted on specimens that were cured 7 days and 28 days respectively.

TABLE 5
Impact resistance of fiber reinforced mortar

| | | Impact resistance | Impact resistance |
|---|---|---|---|
| | | (7 days curing) | (28 days curing) |
| Fiber Description | Sizing | Number of blows | Number of blows |
| Control: No fiber | Not | 8 | 17 |
| | applicable | | |
| Polyoxymethylene | None | 23 | 40 |
| Polyoxymethylene | Sizing 1 | 28 | 53 |
| Polyoxymethylene | Sizing 2 | 24 | 48 |
| Polyoxymethylene | Sizing 3 | 26 | 49 |
| Polyoxymethylene | Sizing 4 | 19 | 36 |

Polyoxymethylene fiber when added into the mortar improved the impact resistance of mortar by more than 100% at both 7 days and 28 days as compared with the control mortar without the fiber reinforcement. These results were higher than the acceptance criteria in ICC-ES AC32, in which an increase of 100% in the 7-days impact resistance and 50% in the 28-days impact resistance is required for the synthetic fibers. Polyoxymethylene fiber with sizing when added to mortar improved the impact resistance of mortar more than polyoxymethylene fiber without sizing.

Compressive strength of mortar was determined on three 8 inch long and 4 inch diameter cylinder specimens of each mortar/fiber formulation following the standard testing method ASTM C39, and using SATEC SYSTEMS Model 5500 supplied by INSTRON and at a loading rate of 35 psi/s.

Compressive strength of fiber reinforced mortar is shown in Table 6. The polyoxymethylene fiber reinforced mortar met the compressive strength requirement in ICC-ES AC32, in which the average compressive strength of three specimens should be at least equal to that of three control mortar specimens. The polyoxymethylene fibers increased the compressive strength of mortar. The mortar that had polyoxymethylene fibers with sizing had higher compressive strength than the mortar with polyoxymethylene fiber with no sizing.

TABLE 6
Compressive strength of fiber reinforced mortar

| Fiber Description | | 28 days compressive |
|---|---|---|
| (cut length) | Sizing | strength, psi |
| Control: No fiber | Not applicable | 5023 |
| Polyoxymethylene (3 mm) | None | 5100 |
| Polyoxymethylene (6 mm) | Sizing 1 | 5360 |
| Polyoxymethylene (3 mm) | Sizing 3 | 5287 |

Construction materials made in accordance with the present disclosure were also tested for free dry shrinkage and plastic shrinkage cracking using Portland cement. The construction material is described in Table 7 below.

TABLE 7
Materials and proportions per batch
for plastic shrinkage cracking test

| Materials | Proportions |
|---|---|
| Type I Portland cement (Holcim USA Inc.) | 87.5 lbs |
| Natural river sand (specific gravity 2.68, absorption 0.56, | 107.5 lbs |
| particle size <2.36 mm) | |
| Water | 32 lbs |
| Microfibers | 1.025 lbs |

The materials were mixed in a 6.0 ft³ rotating drum mixer with a typical batch size of approximately 2.0 to 3.0 ft³ following the procedure similar to the one described in ASTM C192. Water was first added to the mixer followed by the sand and the cement. All materials were mixed for about 3 minutes and rested for 3 minutes. The fibers were then added to the mixture while the mixer was running until the fibers were evenly distributed. This typically took an additional 2 to 3 minutes. After mixing, the fresh mixture was transferred to a wheelbarrow and the specimens were prepared following the procedures given in ASTM C192.

The effects of microfiber reinforcement on the plastic shrinkage cracking were assessed following ASTM C1579. After mixing, the fresh mortar was cast into a 22.5 inch×14 inch×4 inch panel mold and placed in a fan box. Uniform air flow was supplied over the panel surface to achieve a minimum evaporation rate of 0.2 lb/ft²·hour. After the 24 hours exposure, the crack width was measured along the crack path from one side of panel to the other.

The dry shrinkage of cementitious mortar with fiber reinforcement was measured using the standard testing method ASTM C157. The prisms (1×1×11¼ inch) with a gage length of 10 inch were prepared using two compartment metal molds. After mixing, the fresh mortar was placed into the molds, and finished with a steel trowel. After the completion of molding, the specimens were covered with plastic sheets, initially cured in air at 73° F. for 24 hours, and then demolded. After the initial comparator reading was taken, the specimen was stored in an environmental chamber with the constant relative humidity (RH) of 50% and the temperature of 73° F. The final comparator reading was taken after the specimen was stored for 28 days. As a contrast, two more specimens were cured under the lime-saturated water and the comparator readings were also taken immediately after demolding and the 28 days water-curing.

The free shrinkage, expansion and plastic shrinkage cracking control data is shown in Table 8. The polyoxymethylene fibers substantially reduced the free dry shrinkage and expansion of mortar and this is a significant advantage over the commercially available fibers. The polyoxymethylene fibers with sizing had a greater effect than polyoxymethylene without sizing. All specimens expanded when cured in the lime-saturated water. The polyoxymethylene fibers with sizing substantially reduced the expansion of the mortar and this is a significant advantage over the commercially available fibers.

TABLE 8
Free dry shrinkage and plastic shrinkage cracking control of fiber reinforced mortar

| | | | | | | Plastic shrinkage |
|---|---|---|---|---|---|---|
| | | Free dry shrinkage (%) | | | | Plastic shrinkage |
| | | Air dry | | Water curing | | cracking |
| | | Length | Shrinkage | Length | Expansion | Average crack width, |
| Fiber description | Sizing | change | reduction | change | reduction | mm |
| Control: No fiber | Not applicable | −0.0375 | 0 | 0.0130 | 0 | 0.783 |
| Alkali resistant glass | Proprietary | −0.0370 | 1.3 | 0.0125 | −3.8 | 0.039 |
| Polyvinylalcohol | Proprietary | −0.0385 | −2.7 | 0.0175 | 34.6 | 0.011 |
| Polypropylene | Proprietary | −0.0345 | 8 | 0.0115 | −11.5 | 0.010 |
| Polyoxymethylene | None | −0.0195 | 48 | 0.0135 | 3.8 | 0.013 |
| Polyoxymethylene | Sizing 1 | −0.0245 | 34.7 | 0.0115 | −11.5 | 0.012 |
| Polyoxymethylene | Sizing 3 | −0.0090 | 76 | 0.0025 | −80.8 | 0.010 |
| Polyoxymethylene | Sizing 4 | −0.0090 | 76 | 0.0020 | −115.4 | 0.010 |

The polyoxymethylene fibers were found to substantially reduce the width of plastic shrinkage cracking as compared with the control as listed in Table 8. The crack reduction ratios calculated based on the average crack width of fiber reinforced mortar mixture and the average crack width of control mortar mixture were greater than 95%, which is well above the generally accepted criterion of 40% in the industry. This indicated that the polyoxymethylene microfibers were able to effectively control the plastic shrinkage cracking when introduced into the cement mortar/concrete.

For abrasion resistance testing, a 4 inch disk with a 0.4 inch thickness was casted, unmolded after 7 days and allowed to harden 28 days. A 0.4 inch hole was cut in the center of disk. Abrasion resistance was measured on a Taber abrader table using a H-22 wheel with 1000 g load according to ASTM D4060 after 1000 cycles. Weight loss was recorded and given in Table 9.

TABLE 9
Abrasion resistance of microfiber reinforced mortar

| Microfiber | | Weight Loss |
|---|---|---|
| Description | Sizing | (g/1000 cycles) |
| Control: No microfiber | Not applicable | 13.01 |
| Alkali-resistant glass | proprietary | 8.9 |
| Polyvinyl alcohol | proprietary | 11.04 |
| Polypropylene | proprietary | 11.63 |
| Polyoxymethylene | Sizing 3 | 11.71 |
| Polyoxymethylene | Sizing 4 | 9.75 |

A low weight loss is preferred as it indicates a higher surface hardness. Polyoxymethylene microfiber with sizing 4 displays a lower weight loss and an improvement above 10% compared the best performing synthetic microfiber, namely polyvinyl alcohol microfiber.

A self-leveling underlayment (SLU) mortar formulation is shown in Table 10. The commercially available microfibers in this example are: polyvinylalcohol microfiber and polypropylene microfiber, and they have proprietary sizing on them. Drymix/cement ratio was 22%. Microfiber use level is varied between 0.1 wt % and 0.2 wt % on dry weight of SLU mortar. Mortar was mixed in three steps (i) 30 s at speed 1, (ii) wait for 30 s, (iii) and 90 sec at step 2 using a Hobart® mixer according to EN 196.

Plastic and dry shrinkage as well as expansion in the first 24 h of setting and hardening were measured at 23° C., 50% relative humidity using a specialist Schleibinger device, which consists of two commercially available laser units (“Schleibinger cone”) directed horizontally onto a pair of light-weight reflectors, which are placed on top of the fresh mortar. The change in distance between the reflectors is then registered with an accuracy of 0.1 μm.

TABLE 10
Self-leveling underlayment (SLU) mortar formulation
used for the 24 h plastic & drying shrinkage test

| Materials | Proportions |
|---|---|
| Type I Portland cement CEM I 52.5R Heildelberger | 23.00 lbs |
| Zement Milke) | |
| Calium aluminate cement (Lafarge, Lafarge Fondu) | 12.00 lbs |
| Lime (Kalko) | 0.80 lbs |
| Gypsum alpha hemi hydrate | 4.20 lbs |
| Quartz sand 0.1-0.3 mm | 41.75 lbs |
| Natural calcium carbonate (Omya AG, Omyacarb | 15.00 lbs |
| 10 BG) | |
| Tartaric acid | 0.18 lbs |
| Lithium carbonate | 0.20 lbs |
| Powder defoamer (Munzing Chemie, Agitan P823) | 0.12 lbs |
| Polycarboxylate ether superplasticizer powder | 0.15 lbs |
| (Sika AG, Viscokrete 225P) | |
| ethyl hydroxyethyl cellulose rheology modifier | 0.20 lbs |
| (AkzoNobel BV, Bermocoll ® E230X) | |
| Vinylacetate-vinylversatate-ethylene | 2.50 lbs |
| redispersible polymer powder | |
| (AkzoNobel BV, Elotex ® FL3210) | |
| Water | 22 lbs |
| Synthetic microfibers | 0.1 lbs or 0.2 lbs |

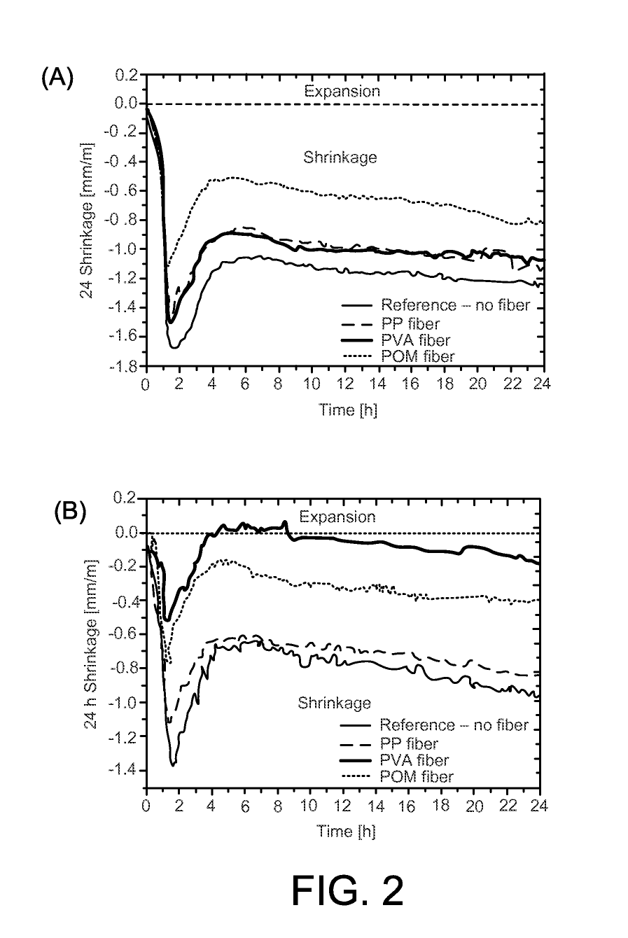

The 24 h plastic and drying shrinkage/expansion curves for polyoxymethylene microfibers in comparison to commercially available synthetic microfibers in self levelling underlayment formulation given in Table 10 in dependence of the microfiber dosage is displayed in FIG. 2.

FIG. 2(A) shows that polyoxymethylene microfibers at low dosage, for instance 0.1 wt % on dry weight of SLU mortar provide higher drying shrinkage compensation compared to polypropylene microfibers. FIG. 1(B) shows that at a dosage of 0.2 wt % on dry weight of SLU mortar polyoxymethylene microfibers provide higher drying shrinkage compensation than polypropylene microfibers as well as expansion control in opposition to polyvinyl alcohol microfibers which tend to expand the SLU formulation due to swelling.

These and other modifications and variations to the present disclosure may be practiced by those of ordinary skill in the art, without departing from the spirit and scope of the present disclosure, which is more particularly set forth in the appended claims. In addition, it should be understood that aspects of the various embodiments may be interchanged either in whole or in part. Furthermore, those of ordinary skill in the art will appreciate that the foregoing description is by way of example only, and is not intended to limit the disclosure so further described in such appended claims.

What is claimed:

1. A fiber made from a polymer composition comprising a polyoxymethylene polymer, the fiber having a length of less than about 30 millimeters, such as less than about 15 millimeters, the fiber having a length greater than about 1 mm, the fiber defining an exterior surface, and wherein residing on the exterior surface of the fiber is a sizing composition.

2. A fiber as defined in claim 1, wherein the fiber comprises a microfiber with a length from about 2 millimeters to about 12 millimeters.

3. A fiber as defined in claim 1, wherein the fiber has a size of less than about 20 denier, and greater than about 0.1 denier.

4. A fiber as defined in claim 1, wherein the polyoxymethylene polymer includes terminal hydroxyl groups in an amount greater than about 10 mmol/kg.

5. A fiber as defined in claim 1, wherein the fiber further comprises a thermoplastic elastomer blended with the polyoxymethylene polymer.

6. A fiber as defined in claim 1, wherein the polyoxymethylene polymer is the product of a copolymerization reaction of trioxane with a cyclic acetal containing at least one O(CH₂)ₙ group where n is greater than 1.

7. A fiber as defined in claim 1, wherein the sizing composition comprises a sizing agent combined with at least one of a lubricant, an emulsifier, and/or an anti-static agent.

8. A fiber as defined in claim 1, wherein the sizing composition contains a sizing agent comprising a hydrophilic silicone.

9. A fiber as defined in claim 1, wherein the sizing composition contains a sizing agent comprising a silane.

10. A fiber as defined in claim 1, wherein the sizing composition contains a sizing agent comprising an alkoxylated alcohol.

11. A fiber as defined in claim 1, wherein the sizing composition contains a sizing agent comprising alkoxylated ester, an alkyl ethoxylate, an alkyl phenyl ethoxylate, an ethoxylated polycarboxylate, a polyether carboxylate, a fatty acid alcohol, a fatty acid ester, a fatty acid polyglycolester, an ethylene oxide copolymer, a propylene oxide copolymer, an alkyl terminated dimethylsiloxane, a hydroxyl terminated dimethylsiloxane, a polysaccharide, a modified starch derivative, a cellulosic derivative, a carboxymethyl cellulose, a methyl cellulose, a cellulose acetate, a polyvinyl alcohol derivative, a polyacrylate, a polyacrylic acid ester, a polyacrylic acid copolymer, a polyacrylic acid terpolymer, a polyester, a polyurethane derivative, a polyisocyanate derivative, a maleic acid copolymer, an ethylene vinyl acetate copolymer, a vinyl acetate ethylene copolymer, or a vinyl versatate copolymer.

12. A construction material comprising:
a binder; and
a plurality of discrete fibers as defined in claim 1.

13. A construction material as defined in claim 12, wherein the binder is comprised of a Portland cement, an aluminosilicate cement, a gypsum material, or a liquid polymer dispersion.

14. A construction material as defined in claim 12, wherein an individual copolymer chain comprises between about 15 and about 20 terminal hydroxyl groups.

15. A construction material as defined in claim 12, the fibers further comprising an impact modifier.

16. A construction material as defined in claim 12, further containing a plasticizer.

17. A construction material as defined in claim 12, wherein the construction material is an industrial drymix mortar, a ceramic tile adhesive, a ceramic tile grout, a flooring compound (underlayment, overlayment), a render, a plaster, a skimcoat, a putty, a technical mortar, a repair mortar, an anchoring grout, or a downhole cementing product.

18. A construction material as defined in claim 12, wherein the construction material after 28 days of curing time has a flexural strength of greater than about 600 psi, has a residual strength of greater than about 180 psi, has an impact resistance of greater than about 45 repeated blows with an impact drop load of 10 lbs, and has a compressive strength of greater than about 5100 psi.

19. A construction material as defined in claim 12, wherein the construction material is a reinforcing plaster or topcoat in an external thermal insulation composite system.

20. A construction material as defined in claim 12, wherein the construction material contains calcium carbonate in an amount of at least 30% by weight.
